(19) United States
(12) Patent Application Publication
(10) Pub. No.: US 2023/0087290 A1
(43) Pub. Date: Mar. 23, 2023

(54) METHOD AND DEVICE FOR CLEARING DEBRIS FROM A MACHINING SPINDLE

(71) Applicant: Steve Mark Bryan, Andrews, IN (US)

(72) Inventor: Steve Mark Bryan, Andrews, IN (US)

(21) Appl. No.: 17/809,292

(22) Filed: Jun. 28, 2022

Related U.S. Application Data
(60) Provisional application No. 63/261,526, filed on Sep. 23, 2021.

(51) Int. Cl. B23B 25/00; B23B 3/30; B08B 9/032

(52) U.S. Cl. CPC B23B 25/00; B08B 9/0328; B23B 3/30; B08B 2209/032

(57) ABSTRACT

A machining system including a first body with a first channel to receive a first stream of compressed air, a second channel to receive a second stream of compressed air, an upper compartment, the first stream of compressed air configured to clear debris from an upper compartment surface and a lower compartment surface when the first stream of compressed air is engaged, the upper compartment configured to shift to a position where the upper compartment abuts the lower compartment and conceals the upper compartment surface and the lower compartment surface when the second stream of compressed air is engaged, and the lower compartment configured to shift when in contact with the upper compartment.

### CROSS-REFERENCE TO RELATED APPLICATION

This application claims the benefit of priority of U.S. provisional application number 63/261,526, filed Sep. 23, 2021, the contents of which are herein incorporated by reference.

### BACKGROUND OF THE INVENTION

The present invention relates to machining spindles and, more particularly, to a method and device for clearing debris from such.

Currently, machining with small tools takes a long cycle time to achieve a desired finish. Reducing cycle time means a part can be made faster. When a part can be made faster, the part becomes cheaper to make. This cheaper a part is to make, the more likely one can underbid competitors to make the part.

Present machines get chips and coolant jammed or debris stuck in them. When machining, it is difficult to keep the coupler clean to ensure no debris enters the air flow system or coupler. Presently, they are not easy to clean or clear automatically.

Moreover, most machines do not typically use more than one spindle at a time. One spindle limits the functionality and throughput of the machine to the capability of a single spindle. Present machines that use more than one spindle at a time are very costly machines, requiring individual tool changers for each spindle head, as opposed to changing them as a set, in a single spindle machine increasing cycle time. Indexing allows for a well-defined cycle of motion. When that cycle of motion must be repeated quickly, easily, and precisely, such as in the mass production of parts, indexing allows for the production of precision parts at a lower cost while reducing cycle times. Machines that use more than one spindle at a time do not allow for an indexable rotation perpendicular to the spindles.

As can be seen, there is a need for a machining tool that cleans itself and clear debris from the coupler . There is also a need for a machining tool that indexably rotates perpendicular to the spindles and uses multiple spindles wherein the tools attached to the spindles may be changed as a set.

### SUMMARY OF THE INVENTION

In one aspect of the present invention, a method of removing debris from an air-driven machining system comprises flowing a first stream of compressed air through a first channel of a receiving framework, removing debris from the receiving framework with the first stream of compressed air as the first stream of compressed air exits an upper compartment of the receiving framework, flowing a second stream of compressed air through a second channel in the receiving framework while simultaneously flowing the first stream of compressed air through the first channel, shifting the upper compartment of the receiving framework downward with the flow of the second stream of compressed air, forcing the upper compartment of the receiving framework to contact a lower compartment of the receiving framework, forming a seal between said upper compartment and said lower compartment, shifting the upper compartment and the lower compartment downward with the second stream of compressed air, and flowing the first stream of compressed air through the upper compartment and the lower compartment.

In another aspect of the present invention, a machining system comprising a first body comprising a first channel configured to receive a first stream of compressed air, a second channel configured to receive a second stream of compressed air, an upper compartment with a first position unmated a lower compartment wherein an upper compartment surface and a lower compartment surface therebetween the upper compartment and lower compartment are exposed, the first stream of compressed air configured to clear debris from the upper compartment surface and the lower compartment surface when the first stream of compressed air is engaged and said surfaces are exposed, the upper compartment configured to shift to a second position, wherein the upper compartment abuts the lower compartment and conceals the upper compartment surface and the lower compartment surface when the second stream of compressed air is engaged, and the lower compartment configured to shift when in contact with the upper compartment, enabling access of the first stream of compressed air to a second body.

These and other features, aspects and advantages of the present invention will become better understood with reference to the following drawings, description, and claims.

### BRIEF DESCRIPTION OF THE DRAWINGS

FIG. 1 is a perspective view of a double spindle embodiment of the present invention;

FIG. 2 is a front view thereof;

FIG. 3 is an exploded view thereof;

FIG. 4 is a section view taken on line 4-4 of FIG. 1;

FIG. 5 is a section view taken on line 5-5 of FIG. 4;

FIG. 6 is a perspective view of a single spindle embodiment of the present invention;

FIG. 7 is a front view thereof;

FIG. 8 is an exploded view thereof;

FIG. 9 is a section view taken on line 9-9 of FIG. 6;

FIG. 10 is a section view taken on line 10-10 of FIG. 9;

FIG. 11 is a section view taken on the line of 11-11 of FIG. 4 illustrating an embodiment of the present invention; and

FIG. 12 is a section view illustrating an embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides an indexable air-driven machining system that allows for the use of a single spindle or two spindles, and effectively removes debris from the air flow path of the machining system while also preventing debris from entering the air flow path.

A general overview of the various features invention will be provided, with a detailed description following. A base, or column, of the machining system may be an indexable base and may indexably rotate perpendicular to the spindle or spindles. The indexable base may comprise an upper index coupling and a coupling base. The indexable rotation occurs at the intersection of the upper index coupling and the coupling base. Rotatable spindles may be positioned at a bottom of the base.

Two sets of teeth are housed within the upper index coupling. The teeth may be locking teeth, configured to join together and lock. A first set of teeth may be fastened to the upper index coupling. A second set of teeth may be fastened to the coupling base and the shank of the machine.

An indexable rotation by the machine tool is permitted when the first set of teeth and the second set of teeth are not mated or locked together. The two sets of teeth may be locked together by a flow of compressed air, prohibiting rotation. Increments of indexable rotation may be proportional to the radial distance between teeth and the size of the teeth, whereas the radial distance and size force alignment of the two sets to a limited number of locked positions, i.e. indexable rotational positions. Rotational positions of the upper index coupling and the coupling base may match or correspond to the indexable rotational positions allowed by the teeth. The indexable rotation enables the rotation of a machine head attached to the spindle or spindles.

Streams of compressed air enter the machining system through a receiving framework. The receiving framework may comprise a coupler body. The compressed air may serve a variety of functions such as locking the teeth of the machining system, driving the spindle or spindles, and removing debris from the machining system coupler. In addition, the compressed air may shirt compartments of the receiving framework, such as an upper compartment and/or a lower compartment, enabling the functions specified above. A time relay device may control when a stream of compressed air enters the machining system.

A first stream of compressed air is operative for cleaning or removing debris from the receiving framework. With no other stream of compressed air engaged, the first stream of compressed air flows through an upper compartment including the coupler body and exits around an upper valve insert as described in more detail in FIG. 12. The first stream of compressed air then collides with a surface of an upper compartment and a surface of the lower compartment. These surfaces may include surfaces of a valve housing, a lower valve seat, a lower valve body, and a ball. The first stream of compressed air thereby removes debris from said surfaces.

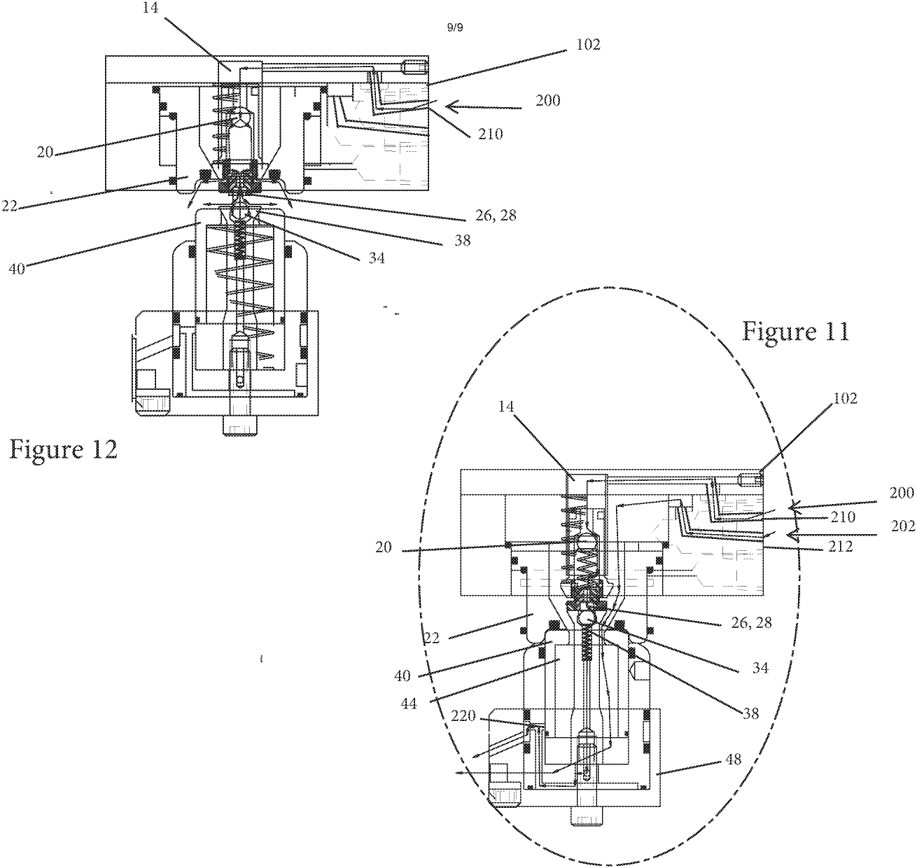

A second stream of compressed air may flow at the delayed time in relationship to the first stream of compressed air, as shown in more detail in FIG. 11. The second stream of compressed air may flow simultaneously to the first stream of compressed air.

The second stream of compressed air forces an upper valve housing, part of the upper compartment, downward and into contact with a lower valve seat, part of the lower compartment, forming a seal between said upper valve housing and said lower valve seat. The upper valve housing and the lower valve seat then shift downwards closing access to an exhaust port. The second stream of compressed air may then flow out of the receiving framework and into the column whereby it flows from the upper into the lower index coupler body and into the spindles, driving a rotation of the spindles. When the second stream of compressed air is engaged, the first stream of compressed air may flow through the upper compartment and the lower compartment, as seen in FIG. 11, then into the column. When the first stream of compressed air enters the upper index coupling, it may lock together the first set of teeth and the second set of teeth, disallowing rotational indexing of the column.

In some embodiments, the second stream of compressed air shifts the upper compartment from a first position (as seen in FIG. 12) to a second position (as seen in FIG. 11). When shifted, the upper compartment abuts a lower compartment and shifts the lower compartment downward, forming a new path for the first stream of compressed air through said compartments. The first stream of compressed air may then flow into the column. When the upper compartment is in the first position, it is unmated to the lower compartment. The surfaces of the upper compartment and surfaces of the lower compartment, said surfaces being between the upper compartment and lower compartment, are exposed. When the upper compartment is in the second position, the upper compartment surfaces and the lower compartment are mated and the surfaces are concealed.

In some embodiments of the present invention, the first air stream engages the machining system for a chosen amount of time controlled by the time relay device. The time relay device then engages both streams simultaneously.

In some embodiments of the present invention, the method of clearing debris with the first stream of compressed air and second stream of compressed air operate independently and apart from the indexable spindles of the column. As such, in said embodiments, the receiving framework and components for clearing debris from the surfaces may detach from the column and form a separate machining device.

In some embodiments, the indexable machining spindles allows for two spindles, or twin spindles, to be loaded within one tool change or 90-degree heads perpendicular to an indexable rotation. Machine shanks attached to this machining system of the present invention may be interchanged by a tool-changer which is part of a computer numerical control machine.

Liquid coolant may be used in the present invention. The liquid coolant enters the column through a shank and flows through an upper coupler base and may exit through a receiver body or continue flowing through the machining system and out a base plate.

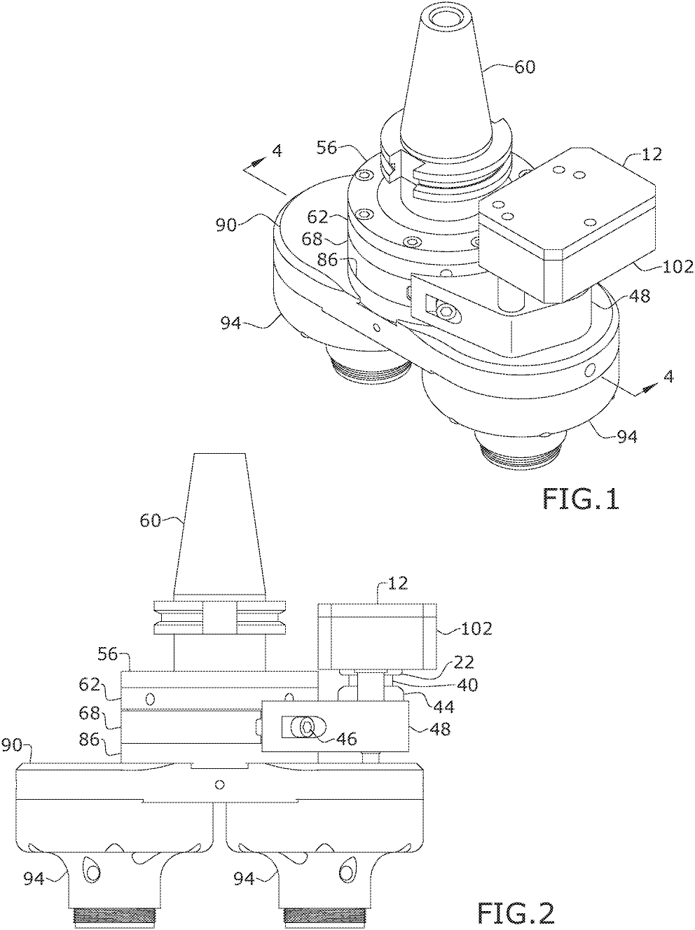

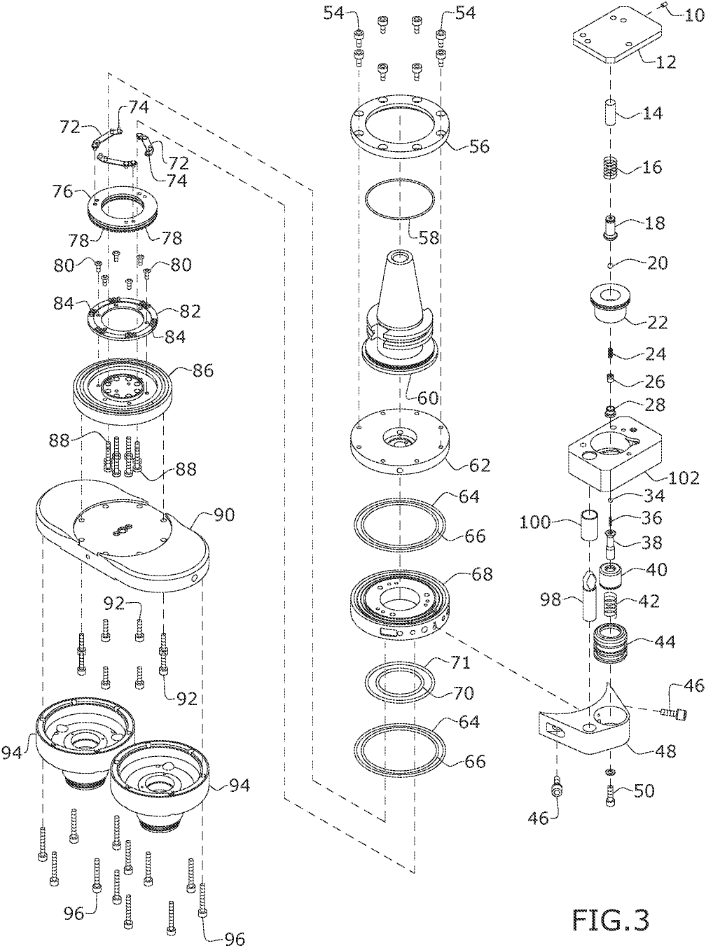

Referring now to FIGS. 1 through 3, a screw 10 plugs an air hole. A cap 12 is joined to a coupler body 102. A sleeve 14, a spring 16, an upper valve body 18, a valve ball 20, a spring 24, an upper valve inner insert 26, and an upper valve insert 28 are housed with an upper valve housing 22. The upper valve housing fits as a piston into the coupler body 102. A ball 34, a spring 36, a lower valve body 38, a lower valve seat 40, and a spring 42 are housed in a lower valve housing 44. The lower valve housing 44 fits firmly into a receiver body 48. A pin 98 fits firmly in the receiver body 48 and a bushing 100 fits firmly in the coupler body 102 aligning the coupler body 102 to the receiver body 48. A bolt 50 fastens the lower valve body 38 to the receiver body 48. A bolt 46 fastens the receiver body 48 to an upper index coupling 68.

Bolts 54 secure a shank ring 56 to an upper coupling base 62. An O-ring 58 is placed on top a shank 60 which is secured between the shank ring 56 and the upper coupling base 62. Springs 72 are secured by retention pins 74 to the upper index coupling 68 and to a piston 76. The piston 76 operates the set of teeth 78 which interlock with a second set of teeth 84 on a lower indexing ring 82. Screws 80 fasten the lower indexing ring 82 to a coupler base 86. Bolts 88 secure the coupler base 86 to the upper coupling base 62 with the lower indexing ring 82, the piston 76, and O-rings 64, 66, 70, 71 in between. Bolts 92 fasten a twin base plate 90 to the coupler base 86. Bolts 96 fasten spindles 94 to the twin base plate 90.

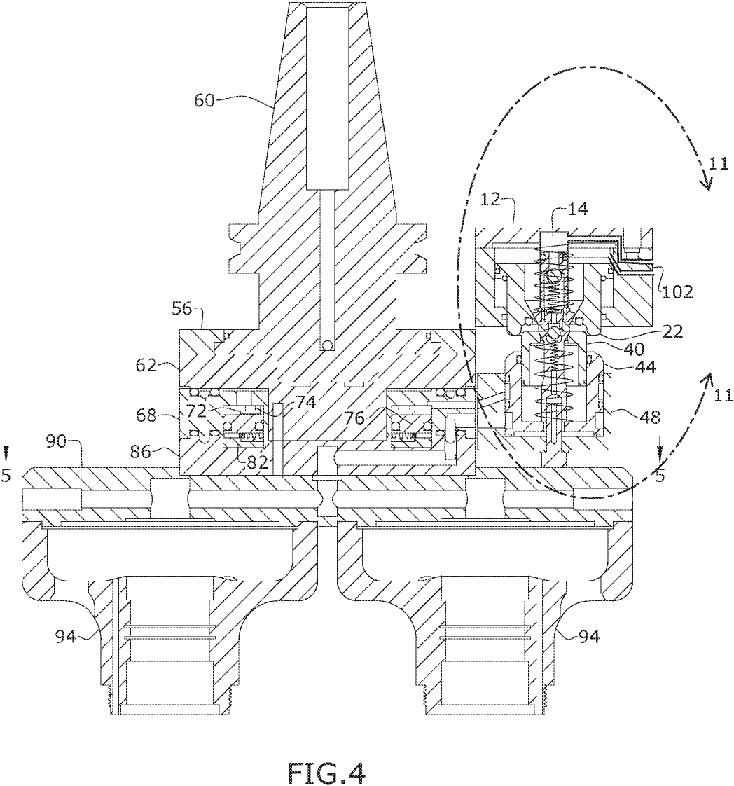

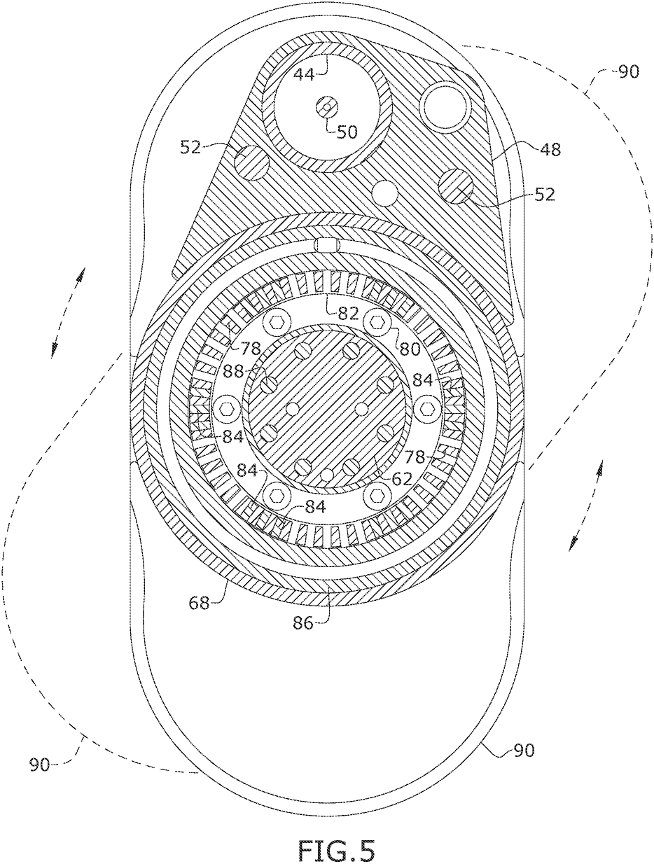

FIG. 4 is a section view taken on line 4-4 of FIG. 1. FIG. 5 is a section view taken on line 5-5 of FIG. 4. FIG. 5 demonstrates an indexable rotational ability of the twin base plate 90 along a plane perpendicular to the spindles 94. This indexable rotation occurs between the upper index coupling 68 and the coupler base 86 (as better seen in FIG. 2). A hole 52 operates to release liquid coolant from the machining system. In this doble spindle embodiment, coolant flows through the shank 60, the upper coupling base 62, into the twin base plate 90 before exiting. Two sets of teeth 78, 84 are operative to determining a magnitude of rotation allowed.

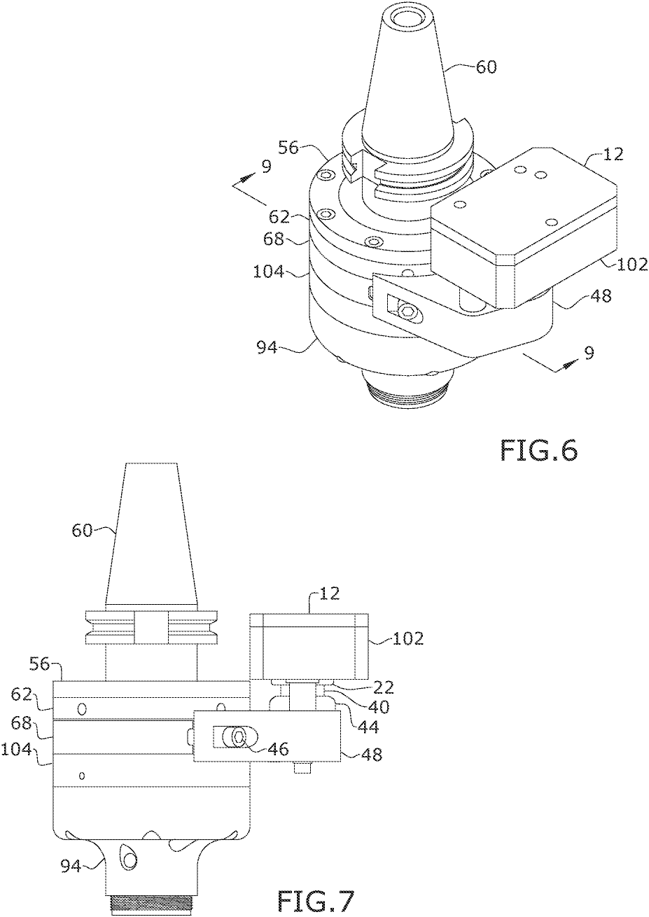

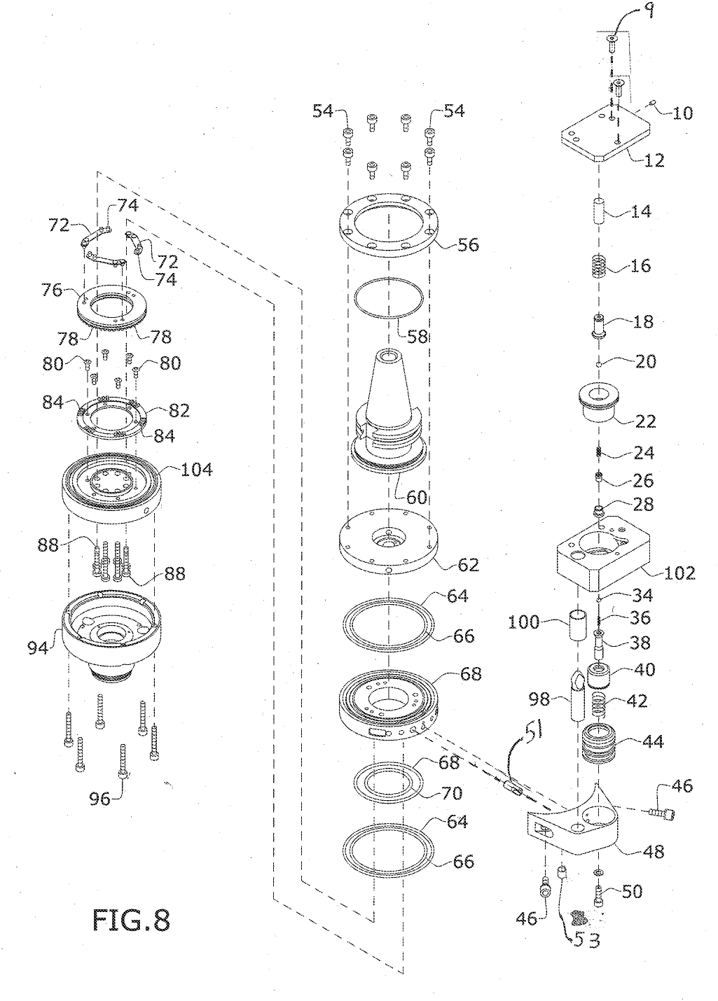

FIGS. 6 through 8 depict a single spindle embodiment of the invention. A screw 9 fastens the cap 12 to the coupler body 102. In the Figures, the coupler base 86 and the twin base plate 90 of FIGS. 1 through 4 are replaced with an indexing single base 104. An eccentric pin 53 secures a pin 51. Removing the eccentric pin 53 enables release of the pin 51 from the upper index coupling 68, enabling a positioning of the receiver body 48 on the upper index coupling 68.

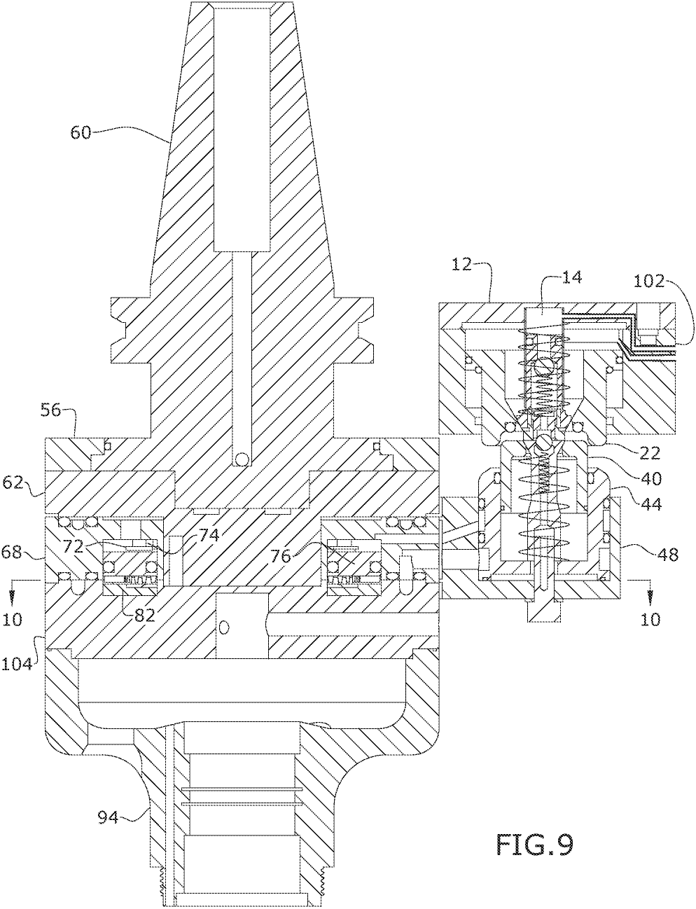

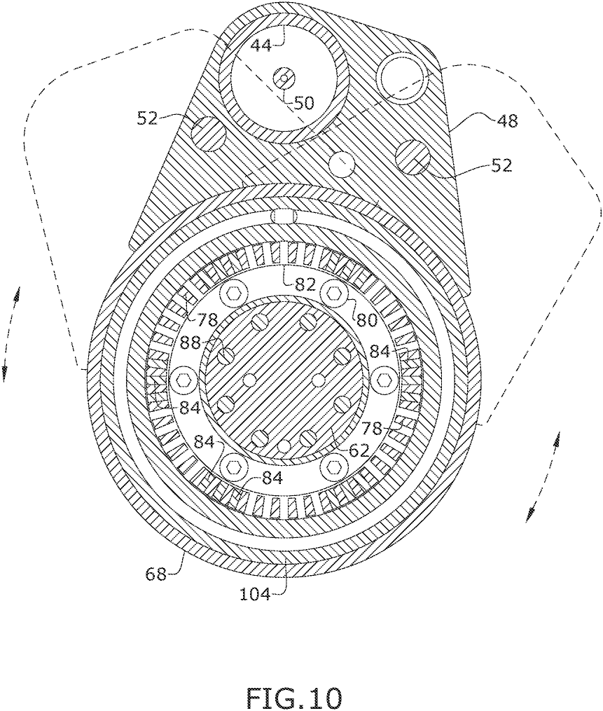

FIG. 9 is a section view taken on line 9-9 of FIG. 6. FIG. 10 is a section view taken on line 10-10 of FIG. 9. FIG. 10 demonstrates an indexable rotational ability of the indexing single base 104. This operates as described in FIG. 5 wherein the coupler base 86 and the twin base plate 90 of FIGS. 1 through 4 are replaced with an indexing single base 104. In this single spindle embodiment, coolant flows through the machine shank 60 into the upper coupling base 62, into the upper index coupling 68, into the receiver body 48, and then out holes 52.

FIG. 11 is a detail view of FIG. 4 taken on line 11-11 in FIG. 4 showing a first body, or a receiving framework comprising a coupler body 102, a receiver body 48, and components therein according to an embodiment of the present invention. A first stream of compressed air 200 and a second stream of compressed air 202 enter the coupler body 102. The second stream of compressed air 202 flows into a second channel 212 of the coupler body 102 and forces the upper valve housing 22 downward and into contact with the lower valve seat 40 forming an air-tight seal between the upper valve housing 22 and the lower valve seat 40. The upper valve housing 22 then forces the lower valve seat 40 downward while maintaining a seal across the two, closing access to an exhaust port 220 by shifting the lower valve seat 40. The second stream of compressed air 202 then flows through the lower valve housing 44 into the upper index coupling 68 and into the spindles 94 (as better seen in FIG. 4).

The first stream of compressed air 200 flows into a first channel 210 of the coupler body 102, into the sleeve 14, around the valve ball 20, through the upper valve inner insert 26, around the ball 34, into the lower valve body 38, and through the exhaust port 220 and into a second body, or a column. The second body comprises a shank 60, a spindle 94, and all components vertically therebetween. The first stream of compressed air then fills the upper index coupling 68, compressing the two sets of teeth 78, 84 housed inside the upper index coupling 68 (as better seen in FIG. 4).

FIG. 12 is similar to FIG. 11 and shows an embodiment of the invention where the first stream of compressed air 200 is engaged but the second stream of compressed air 202 is not engaged. The first stream of compressed air 200, operative to removing debris, flows into the first channel 210 of the coupler body 102, into the sleeve 14, and around the valve ball 20. The first stream of compressed air 200 then exits around the upper valve insert 28, colliding with surfaces of the upper valve housing 22, surfaces of the lower valve seat 40, surfaces of the lower valve body 38, and a surface the ball 34. This process removes debris from said surfaces.

It should be understood, of course, that the foregoing relates to exemplary embodiments of the invention and that modifications may be made without departing from the spirit and scope of the invention as set forth in the following claims.

What is claimed is:

1. A method of removing debris from an air-driven machining system comprising:
flowing a first stream of compressed air through a first channel of a receiving framework;
removing debris from the receiving framework with the first stream of compressed air as the first stream of compressed air exits an upper compartment of the receiving framework;
flowing a second stream of compressed air through a second channel in the receiving framework while simultaneously flowing the first stream of compressed air through the first channel;
shifting the upper compartment of the receiving framework downward with the flow of the second stream of compressed air, forcing the upper compartment of the receiving framework to contact a lower compartment of the receiving framework;
forming a seal between said upper compartment and said lower compartment;
shifting the upper compartment and the lower compartment downward with the second stream of compressed air; and
flowing the first stream of compressed air through the upper compartment and the lower compartment.

2. The method of claim 1, further comprising flowing the second stream of compressed air into a column and driving a spindle attached to the column with the second stream of compressed air.

3. The method of claim 1, further comprising flowing the first stream of compressed air into a column.

4. The method of claim 3, further comprising compressing two sets of teeth housed in an indexable base of the column, with the first stream of compressed air and prohibiting rotation of said indexable base.

5. A machining system comprising:
a first body comprising:
i) a first channel configured to receive a first stream of compressed air;
ii) a second channel configured to receive a second stream of compressed air;
iii) an upper compartment with a first position unmated to a lower compartment, wherein an upper compartment surface and a lower compartment surface therebetween the upper compartment and lower compartment are exposed;
iv) the first stream of compressed air configured to clear debris from the upper compartment surface and the lower compartment surface when the first stream of compressed air is engaged and said surfaces are exposed;
v) the upper compartment configured to shift to a second position, wherein the upper compartment abuts the lower compartment and conceals the upper compartment surface and the lower compartment surface when the second stream of compressed air is engaged; and
vi) the lower compartment configured to shift when in contact with the upper compartment, enabling access of the first stream of compressed air to a second body.

6. The machining system of claim 5, further comprising
the second body affixed to a side of the first body comprising:
i) an indexable base configured to indexably rotate on a plane perpendicular to a spindle below the indexable base;
ii) two sets of locking teeth housed within the second body configured to lock and prohibit rotation of the indexable base when met by the first stream of compressed air; and
iii) at least one rotatable spindle at a bottom of the second body configured to rotate when met by the second stream of compressed air.

7. The machining system of claim 6, further comprising two spindles.

8. The machining system of claim 7, further comprising a tool-changer wherein the two spindles are changed simultaneously by the tool changer.
